(19) United States
(12) Patent Application Publication
(10) Pub. No.: US 2006/0113941 A1
(43) Pub. Date: Jun. 1, 2006

(54) Brushless DC motor controller

(76) Inventor: Patrick D. del Castillo, Olathe, KS (US)

Correspondence Address: CHASE LAW FIRM L.C, 4400 COLLEGE BOULEVARD, SUITE 130, OVERLAND PARK, KS, 66211, US

(21) Appl. No.: 11/288,608

(22) Filed: Nov. 29, 2005

Related U.S. Application Data
(60) Provisional application No. 60/631,650, filed on Nov. 30, 2004.

(51) Int. Cl. H02P 25/12

(52) U.S. Cl. 318/439

(57) ABSTRACT

A controller excites a multi-phase brushless direct current motor and has a power stage provided with output lines connected to corresponding phases of the motor. The power stage is operable to deliver voltages on the output lines in a sequence that executes a commutation. A processor controls the sequence of the power stage and has comparison select outputs. A multiplexer has inputs connected with the respective output lines from the power stage and is responsive to the comparison select outputs for selecting the phases. A comparator is responsive to voltages on the output lines and the phase selected by the multiplexer and, when a predetermined voltage relationship exists, an output is delivered to the processor to cause the power stage to execute a subsequent commutation.

### CROSS REFERENCE TO RELATED APPLICATIONS

This application claims the benefit of prior filed, co-pending Ser. No. 60/631,650, filed Nov. 30, 2004, entitled BRUSHLESS DC MOTOR CONTROLLER.

### BACKGROUND OF THE INVENTION

The present invention relates to controllers for DC motors and, more particularly, to a control circuit having a comparator responsive to back emf signals from a multi-phase brushless DC motor.

One method known in the art to control a three-phase brushless motor is to detect the zero-crossing event between a floating or released phase of the motor and the neutral phase. When the voltage on the released phase is equal to the neutral phase, the next phase is commutated after a predetermined delay period. Each phase is in turn driven, tied to ground and released. The output of a comparator on each of the phases is used for comparison to the neutral voltage. One problem with this method is the voltage offset from one comparator to the next may be significant, especially at low voltages and in an electrically noisy environment resulting in inconsistent or ambiguous comparisons.

Other methods use relatively complex or expensive circuits to determine the phase angle of the rotor using rotor angle sensors or phase angle detectors.

Accordingly, it is desirable to provide a controller for a brushless DC motor which is reliable, simple and relatively inexpensive to produce, and which is particularly adapted for use in radio controlled model vehicles such as airplanes, helicopters, boats and cars.

### SUMMARY OF THE INVENTION

In an embodiment of the present invention a controller has a power stage that excites a multi-phase brushless direct current motor. The power stage delivers voltages on output lines, connected to corresponding phases of the motor, in a sequence that executes a commutation. A processor controls the sequence of the power stage and has comparison select outputs. A multiplexer has inputs connected with the respective output lines from the power stage and is responsive to the comparison select outputs for selecting the phases. A comparator is responsive to voltages on the output lines and the phase selected by the multiplexer and, when a predetermined voltage relationship exists, an output is delivered to the processor to cause the power stage to execute a subsequent commutation.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a diagrammatic illustration of a three-phase direct current brushless motor.

FIG. 2 is a schematic of the control circuit for the motor of FIG. 1.

FIG. 3 is a graphical illustration of the applied and measured voltages for the windings of the motor of FIG. 1.

### DETAILED DESCRIPTION

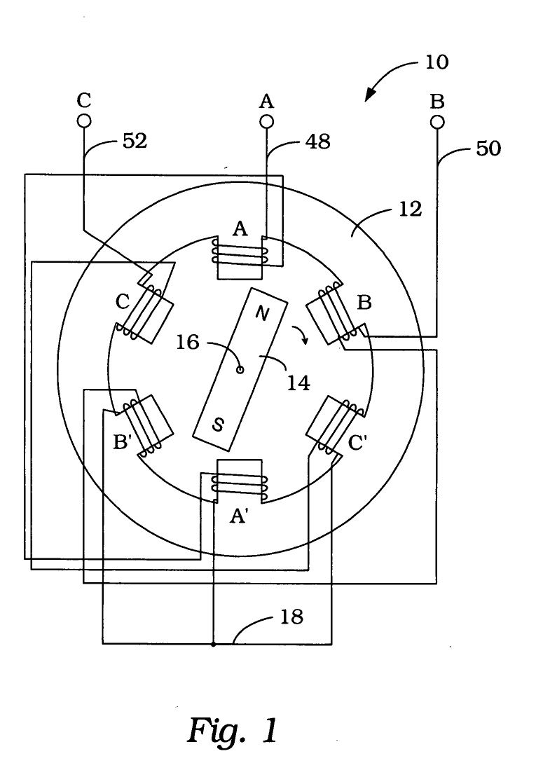

Referring to FIG. 1, a brushless DC motor is generally indicated by reference numeral 10. Motor 10 includes three pairs of windings or coils A-A′, B-B′ and C-C′ on a stator 12 surrounding a rotor 14. Rotor 14 is shown diagrammatically as a bar magnet having a north and a south pole and secured to a shaft 16. Each of the pairs of windings or coils A and A′, B and B′ and C and C′ is connected in series. The coils of each pair are wound in opposite directions so that a current through the pairs of windings creates electromagnet poles on the stator 12 of opposite polarity. By creating electromagnet poles on the stator 12 that attract and/or repel those of the rotor 14, the rotor 14 may be made to rotate by successively energizing and de-energizing the phases. The free ends of coils A′, B′ and C′ are connected together as illustrated at 18.

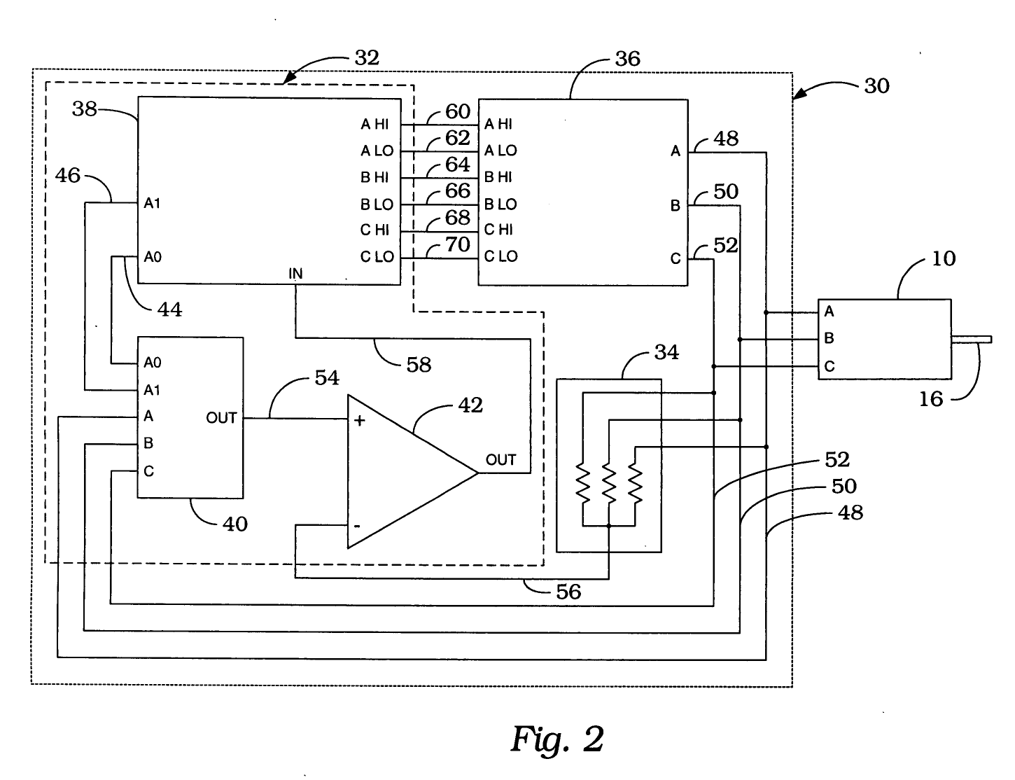

Referring to FIG. 2, a control circuit for motor 10 is generally indicated by reference numeral 30. Controller 30 includes a microcontroller circuit 32, a neutral phase circuit 34 and a power stage circuit 36. Microcontroller circuit 32 includes a microprocessor 38, an analog multiplexer 40 and a comparator 42.

Microprocessor 38 controls the comparison select outputs A0 and A1 to multiplexer 40 on lines 44 and 46, respectively. Accordingly, a digital input to multiplexer 40 is provided on lines 44 and 46 to control the selection of which of the phases, A, B or C, on power stage output lines 48, 50 and 52, respectively, is output on line 54.

Comparator 42 compares the multiplexer output voltage on line 54 with the output of the neutral phase circuit 34 on line 56. When the voltages are equal, an output is generated on line 58 which is input to the microprocessor 38.

Microprocessor 38 also controls the output on lines 60-70 which are input to the power stage circuit 36. Based on the inputs on lines 60-70, the power stage circuit 36 selectively controls the current and voltage for phases A, B and C on lines 48, 50 and 52, respectively.

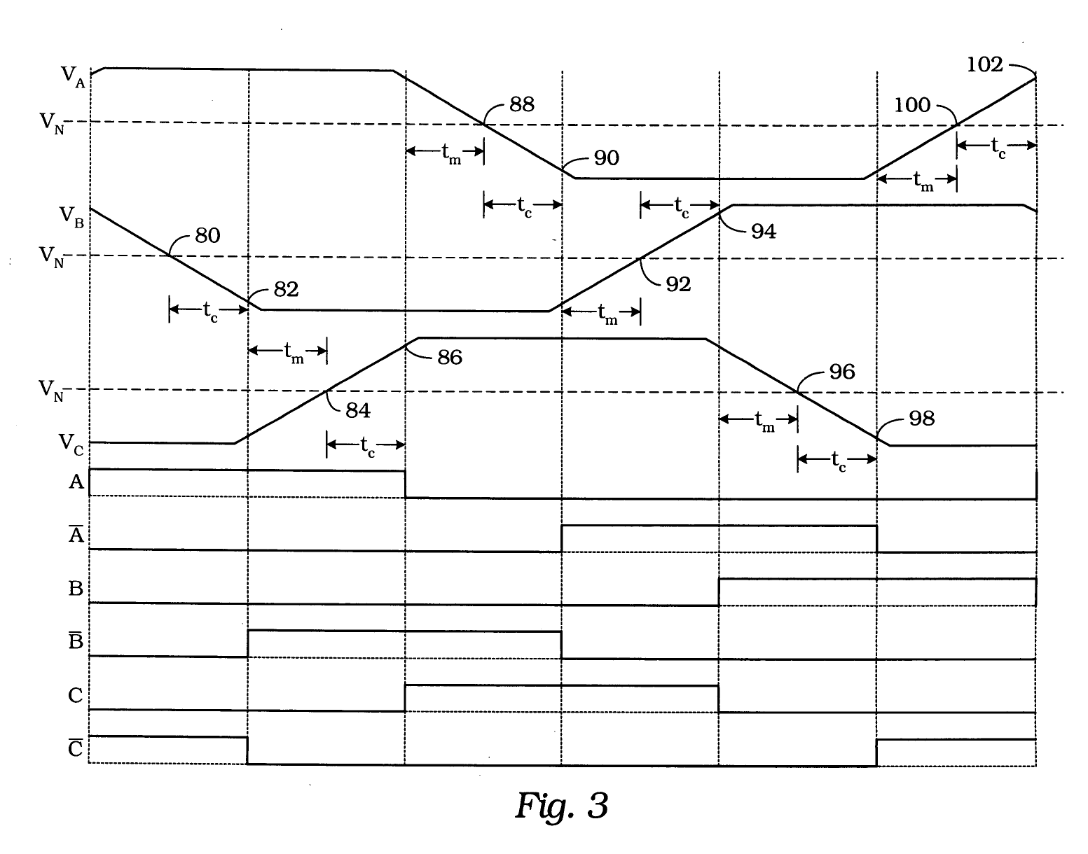

Referring to FIGS. 1-3, in order for motor shaft 16 to turn in a desired direction, the phases A, B and C are activated in a specific order called the commutation sequence. As shown in FIG. 3, this sequence is A\overline{C}, A\overline{B}, \overline{B}C, \overline{A}C, \overline{A}B, B\overline{C}, and repeats thereafter.

In the first period of the sequence, microprocessor 38 outputs a signal on lines 60 and 70 to power stage circuit 36 which applies a positive voltage to phase A on line 48, and a negative voltage to phase C on line 52. As the rotor 14 turns, a voltage is induced in the phase B windings which falls as the north pole of the rotor 14 passes. The neutral voltage (V_{N}) on line 56 is compared by comparator 42 to the back EMF phase B voltage on line 50 through multiplexer 40 and output on line 54. When the voltages on lines 54 and 56 are equal, indicating a zero crossing point 80, an output on line 58 is generated and input to microprocessor 38.

Microprocessor 38 waits a predetermined period of time (discussed below) for the next commutation. At the first commutation point 82 shown in FIG. 3, microprocessor 38 outputs a signal on line 66 and removes the signal on line 70 to power stage circuit 36 which applies a negative voltage to phase B on line 50 and phase C is allowed to float. The microprocessor 38 signals multiplexer 40 on lines 44 and 46 to switch the output on line 54 to phase C on line 52.

As the rotor 14 continues to turn, a voltage is induced in the phase C windings. When the back EMF voltage on line 52 through multiplexer 40 to line 54 equals the neutral voltage on line 56 indicating a zero crossing point 84, an output is generated on line 58 from comparator 42 to microprocessor 38.

The time from commutation point 82 until zero crossing point 84 is measured (tₘ) by microprocessor 38. The commutation time (t_{c}) is set to the measured time tₘ and the microprocessor 38 waits the commutation time period for the next commutation. At the next commutation point 86 a signal is generated by microprocessor 38 on line 68 and removed from line 60 to power stage circuit 36, which applies a positive voltage to phase C on line 52 and removes a voltage on line 48 to allow phase A to float. The microprocessor 38 signals on lines 44 and 46 to multiplexer 40 to switch the output on line 54 to phase A on line 48.

Microprocessor 38 measures the time from commutation point 86 until the zero crossing point 88 for phase A. The commutation time is set to this measured time and the microprocessor waits the commutation time period for the next commutation. At the next commutation point 90, phase A is set to a negative voltage and phase B is allowed to float.

When the back EMF voltage on line 50 is equal to the neutral voltage on line 56, microprocessor 38 waits for the measured period of time from commutation point 90 to the zero crossing point 92 for the next commutation at point 94. At point 94, a positive voltage is applied to phase B, and phase C is allowed to float.

Microprocessor 38 measures the time from commutation point 94 until the zero crossing point 96 for phase C. The commutation time is set to this measured time and the microprocessor 38 waits the commutation time period for the next commutation. At the next commutation point 98, a negative voltage is applied to phase C and phase A is allowed to float. The back EMF voltage on line 48 is compared to the neutral voltage on line 56. Once the zero crossing point 100 for phase A is reached, the microprocessor waits the measured time period from point 98 to point 100 for the next commutation point 102.

At commutation point 102 a positive voltage is applied to phase A on line 48 and phase B is allowed to float. The cycle is then repeated.

Each zero crossing event occurs sixty degrees before the rotor 14 moves to a point where the current phase activation will begin slowing down the rotor and where the next phase activation produces the maximum torque. If the microprocessor 38 waits for 100% of the measured time, the motor will be running at neutral timing. Neutral timing is generally the most efficient mode for running the motor. However, more power can be gained by waiting only a fraction of that time, which is referred to as advanced timing. If the time to commutate to the next phase is only 50% of the measured time, the timing is advanced by 30 degrees.

It is to be understood that while certain forms of this invention have been illustrated and described, it is not limited thereto, except insofar as such limitations are included in the following claims.

Having thus described the invention, what is claimed as new and desired to be secured by Letters Patent is:

1. A method of exciting a multi-phase brushless direct current motor, said method comprising the steps of:
(a) providing a power stage having output lines connected to corresponding phases of said motor, and operable to deliver voltages on said lines in a sequence,
(b) causing said power stage to execute a first commutation,
(c) providing a processor for controlling the sequence of said power stage, and having comparison select outputs,
(d) providing a multiplexer having inputs connected with respective output lines and responsive to said comparison select outputs for selecting said phases, and
(e) comparing the phase selected by said multiplexer with a neutral phase of said motor and, when a predetermined voltage relationship exists, delivering an output to said processor to cause said power stage to execute a subsequent commutation.

2. The method as claimed in claim 1, wherein said step (e) includes measuring the time from said first commutation to said predetermined voltage relationship, and executing said subsequent commutation based on said measured time.

3. The method as claimed in claim 1, wherein said step (e) includes measuring the time from said first commutation to said predetermined voltage relationship, and executing said subsequent commutation upon the expiration of said measured time.

4. The method as claimed in claim 1, wherein said step (e) includes measuring the time from said first commutation to said predetermined voltage relationship, and executing said subsequent commutation in less than said measured time.

5. The method as claimed in claim 1, further comprising the step of repeatedly executing step (e) to repeatedly commutate the motor.

6. Apparatus for exciting a multi-phase brushless direct current motor, said apparatus comprising:
(a) a power stage having output lines connected to corresponding phases of said motor, and operable to deliver voltages on said lines in a sequence to execute a first commutation,
(b) a processor for controlling the sequence of said power stage, and having comparison select outputs,
(c) a multiplexer having inputs connected with respective output lines and responsive to said comparison select outputs for selecting said phases, and
(d) a comparator responsive to the voltages on said output lines and the phase selected by said multiplexer and, when a predetermined voltage relationship exists, delivering an output to said processor to cause said power stage to execute a subsequent commutation.

7. The apparatus as claimed in claim 6, wherein said processor measures the time from said first commutation to said predetermined voltage relationship, and executes said subsequent commutation based on said measured time.

8. The apparatus as claimed in claim 6, wherein said processor measures the time from said first commutation to said predetermined voltage relationship, and executes said subsequent commutation upon the expiration of said measured time.

9. The apparatus as claimed in claim 6, wherein said processor measures the time from said first commutation to said predetermined voltage relationship, and executes said subsequent commutation in less than said measured time.
